(19) United States
(12) Patent Application Publication
(10) Pub. No.: US 2021/0153651 A1
(43) Pub. Date: May 27, 2021

(54) COUPLING BRIDGE FOR FOOD PREPARATION APPLIANCES

(71) Applicant: John Mark Summers, Atlanta, GA (US)

(72) Inventor: John Mark Summers, Atlanta, GA (US)

(21) Appl. No.: 16/698,239

(22) Filed: Nov. 27, 2019

(51) Int. Cl. A47B 95/00

(52) U.S. Cl. CPC A47B 95/00; A47J 37/1271

(57) ABSTRACT

A coupling bridge to prevent the accumulation of food products and cooking oils on the sidewalls of adjacent food preparation appliances. The coupling bridge is formed of a steel plate having a top plate with first and second legs downwardly extending from opposed sides of the top plate. The top plate has a width corresponding to a gap between the adjacent food preparation appliances and a width of each of the sidewall of the first cooking appliance and the adjacent sidewall of the second cooking appliance. The coupling bridge is reversible in orientation to accommodate a handedness disposition of the first and the second cooking appliance.

### BACKGROUND OF THE INVENTION

The present invention relates to food preparation areas and, more particularly, to appliances in food preparation areas.

Food product and cooking oil spillage between commercial/industrial food preparation appliances can present significant sanitation issues. While present in many areas of a kitchen, deep-fryers and fry stations present a particular challenge. Cooking oils dripping from a cooking basket and foods items contained in the cooking basket are particularly difficult. Dripping oils are prone to run down the gap between the adjacent sidewalls walls of the fryer and a fry station as the food items are transferred from cooking in the fryer and portioned at the fry station.

To maintain the cleanliness of the cooking area, one of the adjacent appliances needs to be moved to eliminate this potential source of surface contamination. This can present a burn hazard to the workers in that the cooking oils within the fryer are at a high temperature and can remain so for an extended duration, even after power to the fryer has been removed. Even if the fry portioning station is moved, the close proximity with the fryer still presents a potential hazard to workers.

As can be seen, there is a need for an improved apparatus for preventing dripping oils from soiling adjacent food preparation appliances.

### SUMMARY OF THE INVENTION

In one aspect of the present invention, a coupling bridge for bridging a gap between adjacent food preparation appliances is disclosed. The coupling bridge has a top plate having a width to span the gap, a width of a sidewall of a first food preparation appliance, and a width of an adjacent sidewall of a second food preparation appliance. A first leg extends downwardly from a first side edge of the top plate. A second leg extends downwardly from a second side edge of the top plate parallel to the first leg.

In some embodiments, a length of the coupling bridge is dimensioned to correspond to a length of a top opening of one of the first food preparation appliance and the second food preparation appliance.

In other embodiments, a length of the first leg is dimensioned to extend from a top surface of the first sidewall and extend into a top opening of the first cooking appliance. In some instances the first cooking appliance is a cooking oil fryer station.

In other embodiments, a length of the second leg is dimensioned to extend into an opening of the second cooking appliance along an interior surface of the adjacent sidewall. The second cooking appliance may be a food portioning station.

In other aspects of the invention, a method of preventing the accumulation of food products on a sidewall of adjacent food preparation appliances is disclosed. The method includes forming a coupling bridge having a top plate with a width to span a gap, a width of a sidewall of a first food preparation appliance, and a width of an adjacent sidewall of a second food preparation appliance, a first leg extending downwardly from a first side edge of the top plate, and a second leg extending downwardly from a second side edge of the top plate parallel to the first leg. The coupling bridge is installed to cover the gap between the adjacent food preparation appliances, wherein the first leg extends into a top opening of the first food preparation appliance and the second leg extends into a top opening of the second food preparation appliance.

In some embodiments a length of the coupling bridge is dimensioned to correspond to a length of the top opening of one of the first food preparation appliance and the second food preparation appliance.

In other embodiments, the method includes periodically wiping an outer surface of the coupling bridge to remove accumulated food products.

In yet other steps, the method includes removing the coupling bridge from between the adjacent food preparation appliances.

With the coupling bridge removed, an inner surface and an outer surface of the coupling bridge can be cleaned.

These and other features, aspects and advantages of the present invention will become better understood with reference to the following drawings, description and claims.

### BRIEF DESCRIPTION OF THE DRAWINGS

FIG. 1 is a perspective view of the coupling bridge, shown in use;

FIG. 2 is a perspective view of the coupling bridge;

FIG. 3 is a detail perspective view of the coupling bridge, illustrating an installation onto a food service preparation area;

FIG. 4 is a section view of the coupling bridge, taken along line 4-4 in FIG. 1

FIG. 5 is a front elevation view of the coupling bridge; and

FIG. 6 is a top plan view of the coupling bridge.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provides an improved apparatus and method for preventing the spillage of cooking oils and food product between adjacent food preparation appliances.

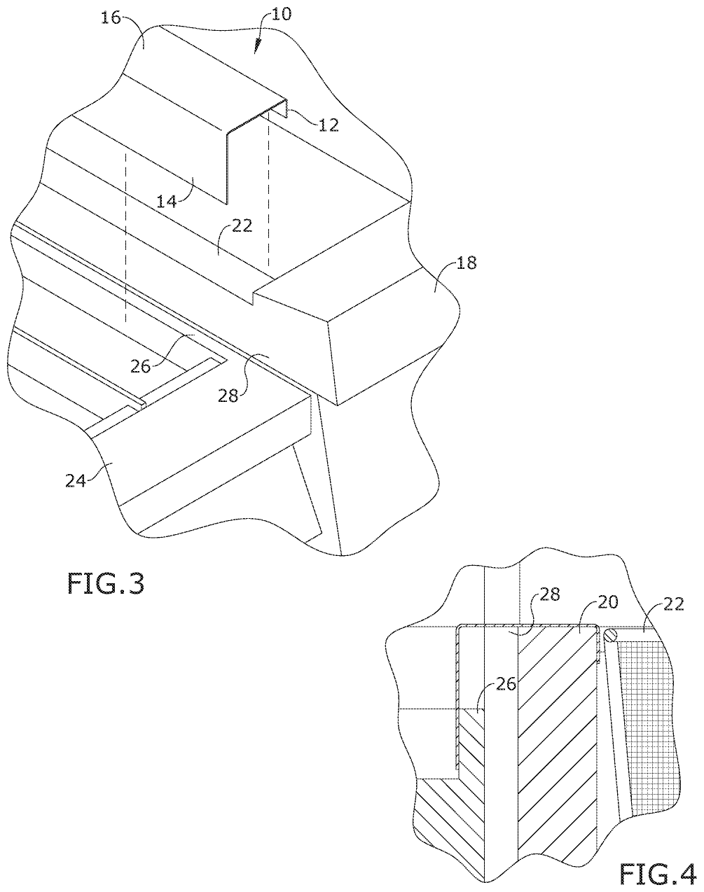

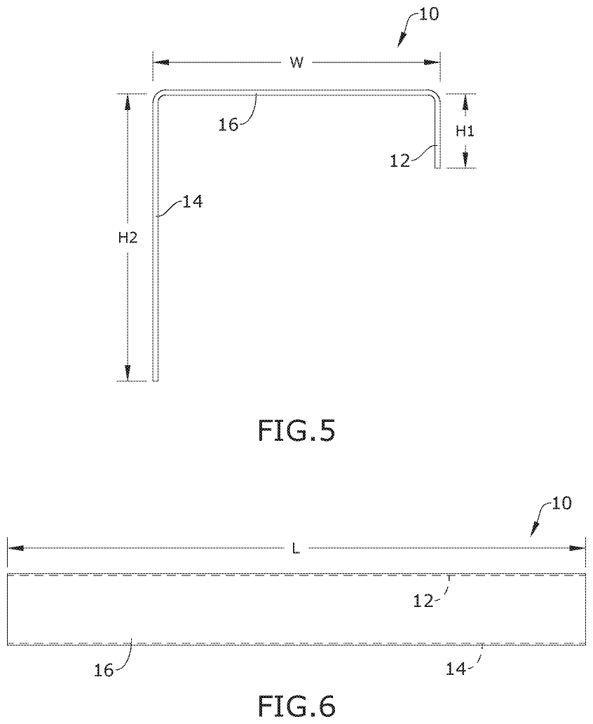

As seen in reference to the drawings of FIGS. 1, 3, and 4, a food preparation area, such as a commercial kitchen is shown. The food preparation area includes adjacent appliances. In the non-limiting embodiment shown, the adjacent appliances include a deep fryer 18 and a fry portioning station 24. A fryer basket 22 is typically immersed in a vat of heated cooking oils where the basket contains the food product, such as French fries, that are cooked in the heated oil. When the food product is cooked, the fryer basket 22 is removed from the vat of oil and the food product is transferred to the portioning station 24.

A gap 28 between the adjacent food preparation appliances 18, 24 is protected from food product and oil spillage by a coupling bridge 10 of the present invention. The coupling bridge 10 prevents dripping of food items and cooking oils through the gap and adhering along the adjacent sidewalls 20, 26 of the food preparation appliances 18, 24.

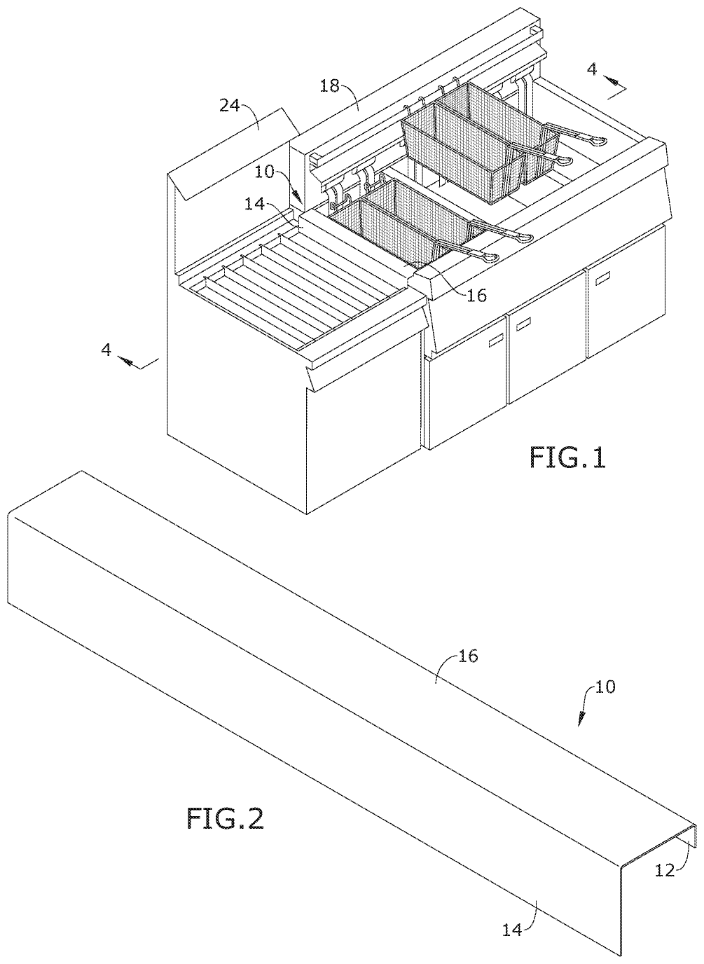

As seen in reference to FIGS. 2-4, the coupling bridge 10 is formed of a sheet of steel, preferably stainless steel to facilitate cleaning of the coupling bridge 10. The coupling bridge 10 has a first leg 12 and a second leg 14 that extend along opposite ends of a bridge plate 16. The first leg 12 has a height H1 to permit the first leg 12 to extend into a top opening of the first appliance 18 while a top surface of the first appliance sidewall 20 is positioned subjacent to a bottom surface of the bridge plate 16 so that the coupling bridge 10 is supported along a top surface of the first appliance 18.

The second leg 14 has a length H2 that extends past a top surface of the sidewall 26 of the second appliance 24. The bridge plate 16 has a width W corresponding to a width of the top surface of the first appliance sidewall 20, a width of the top surface of the second sidewall 26, and a width of the gap 28 between the first sidewall 20 and the second sidewall 26. The coupling bridge 10 has a length corresponding to a length of the top opening of the first appliance 18 and the second appliance 24.

As will be appreciated from the drawings, the opening of one of the first appliance 18 and the second appliance 24 may be lower than that of the other. Accordingly, the length of the first leg H1 may be dissimilar to that of the length of the second leg H2. Depending on the relative placement, left handed or right handed, of the first appliance 18 and the second appliance 24, the coupling bridge 10 may be rotated 180 degrees to position the first leg 12 in the higher of the two appliances opening and the second leg 14 in the lower of the tow appliance openings.

In use, the coupling bridge 10 is placed over the gap 28 between the respective first and second appliances 18, 24. As the cook withdraws the basket 22 from the fryer vat and transfers the cooked food product to the food portioning appliance, the dripping oil will be blocked by the coupling bridge 10. The coupling bridge 10 may be wiped from time to time to prevent accumulation of excess oils. For more thorough cleaning, the coupling bridge 10 may be readily removed and cleaned.

It should be understood, of course, that the foregoing relates to exemplary embodiments of the invention and that modifications may be made without departing from the spirit and scope of the invention as set forth in the following claims.

What is claimed is:

1. A coupling bridge for bridging a gap between adjacent food preparation appliances, comprising:
a top plate having a width to span the gap, a width of a sidewall of a first food preparation appliance, and a width of an adjacent sidewall of a second food preparation appliance;
a first leg extending downwardly from a first side edge of the top plate; and
a second leg extending downwardly from a second side edge of the top plate parallel to the first leg.

2. The coupling bridge of claim 1, wherein a length of the coupling bridge is dimensioned to correspond to a length of a top opening of one of the first food preparation appliance and the second food preparation appliance.

3. The coupling bridge of claim 2, wherein a length of the first leg is dimensioned to extend from a top surface of the sidewall and extend into a top opening of the first preparation appliance.

4. The coupling bridge of claim 3, wherein the first preparation appliance is a cooking oil fryer station.

5. The coupling bridge of claim 2, wherein a length of the second leg is dimensioned to extend into an opening of the second food preparation appliance along an interior surface of the adjacent sidewall.

6. The coupling bridge of claim 5, wherein the second preparation appliance is a food portioning station.

7. A method of preventing an accumulation of food products on a sidewall of adjacent food preparation appliances, comprising:
forming a coupling bridge having a top plate with a width to span a gap, a width of a sidewall of a first food preparation appliance, and a width of an adjacent sidewall of a second food preparation appliance, a first leg extending downwardly from a first side edge of the top plate, and a second leg extending downwardly from a second side edge of the top plate parallel to the first leg; and
installing the coupling bridge to cover the gap between a pair of adjacent food preparation appliances, wherein the first leg extends into a top opening of the first food preparation appliance and the second leg extends into a top opening of the second food preparation appliance.

8. The method of claim 7, wherein a length of the coupling bridge is dimensioned to correspond to a length of the top opening of one of the first food preparation appliance and the second food preparation appliance.

9. The method of claim 8, further comprising:
periodically wiping an outer surface of the coupling bridge to remove accumulated food products.

10. The method of claim 8, further comprising:
removing the coupling bridge from between the adjacent food preparation appliances.

11. The method of claim 10, further comprising:
cleaning an inner surface and an outer surface of the coupling bridge.
